(19) United States
(12) Patent Application Publication
(10) Pub. No.: US 2023/0012928 A1
(43) Pub. Date: Jan. 19, 2023

(54) DEVICE AND METHOD FOR FILLING TANKS

(71) Applicant: L'Air Liquide, Societe Anonyme pour I'Etude et l'Exploitation des Procedes Georges Claude, Paris (FR)

(72) Inventors: Tom RONY, Sassenage (FR); Thibaut FRANCOIS, Sassenage (FR)

(73) Assignee: L'Air Liquide, Societe Anonyme pour l'Etude et l'Exploitation des Procedes Georges Claude, Paris (FR)

(21) Appl. No.: 17/786,729

(22) PCT Filed: Nov. 12, 2020
(86) PCT No.: PCT/EP2020/081904

§ 371 Date: Jun. 17, 2022

(30) Foreign Application Priority Data
Dec. 17, 2019 (FR) FR 1914629

(51) Int. Cl. F17C 5/06

(52) U.S. Cl. CPC F17C 5/06; F17C 2225/0123; F17C 2221/012; F17C 2250/032; F17C 2205/0329; F17C 2250/043; F17C 2265/012; F17C 2227/0157; F17C 2223/036; F17C 2225/036

(57) ABSTRACT

Device and method for filling pressurized gas tanks, comprising a pressurized gas source, a transfer pipe connected to a tank to be filled, the transfer pipe comprising a set of valve(s) and a compressor, the device comprising a sensor for detecting the presence of oil in the gas flowing in the transfer pipe downstream of the compressor, the device comprising a bypass pipe connected to the transfer pipe downstream of the compressor and comprising a set of at least two valve(s) in series which are configured to enable, in a first configuration, the gas flowing in the transfer pipe to be extracted in the bypass pipe and, in a second configuration, fluid isolation between the bypass pipe and the transfer pipe, wherein the valve assembly of the transfer pipe defines in the second configuration a closed storage space for the gas extracted and enclosed in the bypass pipe, the closed storage space comprising a pressure relief system for the gas extracted and enclosed in the bypass pipe for lowering the pressure of the enclosed gas to a pressure lower than the pressure of the gas flowing in the transfer pipe, the oil presence detection sensor detecting oil in the closed storage space.

### CROSS-REFERENCE TO RELATED APPLICATIONS

This application is a § 371 of International PCT Application PCT/EP2020/081904, filed Nov. 12, 2020, which claims § 119(a) foreign priority to French patent application FR 1914629, filed Dec. 17, 2019.

### BACKGROUND

### Field of the Invention

The invention relates to a device and a method for filling tanks.

The invention relates more particularly to a device for filling pressurized gas tanks, in particular pressurized hydrogen tanks, comprising a source of pressurized gas, a transfer pipe having an upstream end connected to the source and a downstream end intended to be connected to a tank that is to be filled, the transfer pipe comprising a set of valve(s) for controlling the flow of gas from the source towards the downstream end, the transfer pipe comprising a compressor, the device comprising a sensor for detecting the presence of oil in the gas flowing in the transfer pipe downstream of the compressor, the device comprising a bypass pipe connected to the transfer pipe downstream of the compressor.

### Related Art

It may be necessary to detect the presence of oil at the compressor outlet to check whether an oil leak is contaminating the compressed gas. This may be of particular relevance to hydrogen filling stations.

A known technology consists in using a coalescing filter and an optoelectronic oil level sensor. Most sensors, and in particular this type of sensor, cannot withstand pressures above 500 bar. This is incompatible with the very high pressures reached in certain filling devices, in particular for pressurized hydrogen.

### SUMMARY OF THE INVENTION

One aim of the present invention is to overcome all or some of the drawbacks of the prior art set out above.

To that end, the device according to the invention, which is moreover in accordance with the generic definition thereof given in the preamble above, is essentially characterized in that the bypass pipe comprises a set of at least two valve(s) in series configured to allow, in a first configuration, the drawing-off of gas flowing in the transfer pipe into the bypass pipe and, in a second configuration, fluidic isolation between the bypass pipe and the transfer pipe, in which the set of valve(s) of the transfer pipe defines in the second configuration a closed storage volume for the drawn-off gas trapped in the bypass pipe, the closed storage volume comprising a system for reducing the pressure of the drawn-off gas trapped in the bypass pipe to lower the pressure of the trapped gas to a pressure lower than the pressure of the gas flowing in the transfer pipe, the sensor for detecting the presence of oil providing detection of oil in said closed storage volume.

Furthermore, embodiments of the invention can comprise one or more of the following features:
the bypass pipe comprises an upstream end connected to the transfer pipe downstream of the compressor and a downstream end, the bypass pipe comprising, arranged in series between its upstream and downstream ends: a first isolation valve, a second isolation valve and a third isolation valve,
the sensor for detecting the presence of oil measures the presence of oil between the second isolation valve and the third isolation valve,
the downstream end of the bypass pipe is connected to an oil recovery member,
the system for reducing the pressure of the drawn-off gas comprises at least one of: a calibrated orifice, an increase in section of the bypass pipe,
the device comprises a pressure sensor measuring the pressure in the closed storage volume of the bypass pipe,
the device comprises a pipe for evacuating the gas trapped in the closed storage volume formed in the bypass pipe, the evacuation pipe comprising an upstream end connected to the bypass pipe in the closed storage volume and a downstream end connected to a discharge volume, the evacuation pipe comprising a set of isolation valve(s),
the discharge volume comprises at least one among: the atmosphere, a zone of the transfer pipe located upstream of the compressor, the pressurized gas source,
the device comprises an electronic controller comprising a data storage and processing device such as a microprocessor or a computer, said electronic controller being connected to the sensor for detecting the presence of oil, and being configured to generate a signal in the event of oil being detected by said sensor,
the electronic controller is connected to all or some of the valves of the device and is configured to control said valves,
the sensor for detecting the presence of oil comprises a coalescing filter and a level sensor of the optoelectronic type,
the pressure of the gas flowing in the transfer pipe downstream of the compressor is between 500 and 1200 bar, and in that the volume of drawn-off and trapped gas being expanded in the closed storage volume at a pressure of between 500 and 100 bar,
the drawn-off gas volume is trapped in a first section of the bypass pipe then expanded in the closed volume having a volume greater than the volume of the first section of the bypass pipe.

The invention also relates a method for filling pressurized gas tank(s), in particular pressurized hydrogen tanks, in which pressurized gas is transferred from a pressurized gas source into a tank via a transfer pipe comprising a compressor, the method comprising detecting the presence of oil in the gas flowing in the transfer pipe downstream of the compressor, the method comprising a step of drawing-off a volume of gas flowing in the transfer pipe downstream of the compressor towards a bypass pipe, said volume of drawn-off gas being trapped and expanded in a closed storage volume, the detection of the presence of oil being carried out in said trapped and expanded drawn-off gas volume.

According to other possible distinctive features:

The invention may also relate to any alternative device or method comprising any combination of the features above or below within the scope of the claims.

### BRIEF DESCRIPTION OF THE FIGURES

Other features and advantages will appear from reading the following description, which is given with reference to the figures, in which:

FIG. 1 is a schematic and partial view illustrating a first example of the structure and operation of a filling device according to the invention,

FIG. 2 is a schematic and partial view illustrating a second example of the structure and operation of a filling device according to the invention.

### DETAILED DESCRIPTION OF THE INVENTION

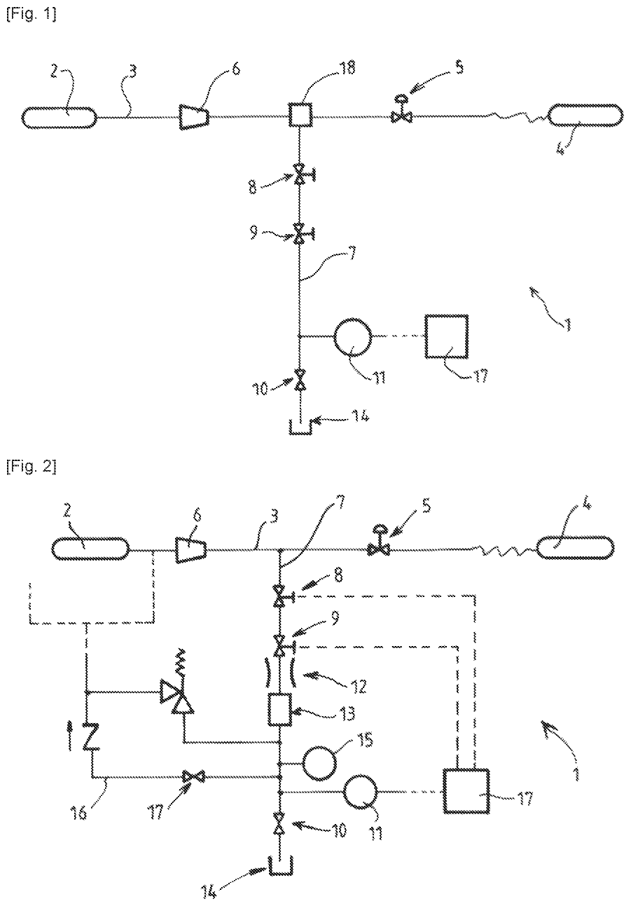

The pressurized-gas tank filling device 1 illustrated in [FIG. 1] may notably be used for filling pressurized hydrogen tanks. This device comprising a source 2 of pressurized gas (pressurized storage, liquid storage associated with a pump and/or a vaporizer, electrolyzer(s), etc.).

The filling device 1 comprises a transfer pipe 3 having an upstream end connected to the at least one source 2 and at least one downstream end intended to be connected to a tank 4 that is to be filled. Of course, multiple downstream ends can be provided to fill several separate tanks 4, either simultaneously or non-simultaneously.

The transfer pipe 3 can conventionally comprise a set of valve(s) 5 to control the flow of gas from the source 2 towards the downstream end, for example a controlled valve 5 for controlling the flow rate and/or the pressure. Other members can conventionally be provided on this transfer pipe 3, in particular at least one among: a gas cooling member, an isolation valve, pressure and/or temperature sensor(s).

The transfer pipe 3 comprises at least one compressor 6 and the device 1 comprises a sensor 11 for detecting the presence of oil in the gas flowing in the transfer pipe 3 downstream of the compressor 6. To avoid exposing the sensor 11 to too high a pressure, the device 1 comprises a bypass pipe 7 connected to the transfer pipe 3 downstream of the compressor 6. The bypass pipe 7 preferably comprises a set of at least two valve(s) 8, 9, 10 in series configured such that, in a first configuration, they allow gas flowing in the transfer pipe 3 to be drawn off into the bypass pipe 7 and, in a second configuration, they fluidically isolate the bypass pipe 7 from the transfer pipe 3. In the second configuration, the set of valve(s) 8, 9, 10 of the transfer pipe 3 defines a closed storage volume for the drawn-off gas trapped in the bypass pipe 7. The closed storage volume includes a system for reducing the pressure of the gas drawn-off at very high pressure and trapped in the bypass pipe 7 to lower the pressure of the trapped gas to a pressure lower than the pressure of the gas flowing in the transfer pipe 3. The sensor 11 for detecting the presence of oil measures the presence of oil in said closed storage volume, that is to say that it is exposed to a pressure below that of the gas flowing in the transfer pipe 3.

That is to say that gas at very high pressure is drawn-off from the outlet of the compressor 6 and is expanded before any presence of oil therein is detected.

In the illustrated examples, the bypass pipe 7 comprises an upstream end connected to the transfer pipe 3 downstream of the compressor 6 and a downstream end. The bypass pipe 7 comprises, arranged in series between its upstream and downstream ends: a first isolation valve 8, a second isolation valve 9 and a third isolation valve 10.

In normal operation (when filling a tank 4 for example), the first isolation valve 8 is open and the second isolation valve 9 is closed. If oil is contained in the very high pressure gas supplied by the compressor, this oil will penetrate with the gas which contains it into the volume of the bypass pipe 7 located between the first 8 and second 9 isolation valves.

A filter 18 can be arranged at the intersection between the transfer pipe 3 and the bypass pipe 7 and/or in the bypass pipe 7 to collect this possible oil.

When the oil level is to be checked, the first isolation valve 8 can be closed and then the second isolation valve 9 can be opened. When the second isolation valve 9 opens, the small volume of hydrogen and oil that is trapped will expand into a larger closed storage volume. This volume can be obtained by providing, downstream of the second isolation valve 9, pipes of larger diameter and/or a length of pipes that is sufficient to increase the volume for the trapped gas.

For example, the bypass pipe 7 may comprise an increase in section 13 of its piping downstream of the second isolation valve 9.

For example, before opening the second isolation valve 9, the pressure downstream of this second isolation valve 9 may be relatively lower than in the transfer pipe 3, for example less than 200 bar.

The volume between the first two isolation valves 8, 9, and the closed storage volume when the second isolation valve 9 is open, can be dimensioned relatively to reduce the pressure in the closed storage volume to below the value of maximum pressure that the sensor 11 can withstand.

Thus, the sensor can detect the possible presence of oil without being exposed to excessive pressure.

When the detection has been carried out, the trapped gas must be evacuated to carry out another measurement.

As illustrated in [FIG. 2], the device may comprise a pipe 16 for evacuating the gas trapped in the closed storage volume. This bypass pipe 7 may comprise an upstream end connected to the bypass pipe 7 in the closed storage volume (for example between the second 9 and third 10 isolation valves). The bypass pipe 7 has a downstream end connected to a discharge volume. The evacuation pipe 16 includes a set of isolation valve(s) 17.

As shown schematically in dotted lines, the downstream end can be connected to an evacuation zone (vent to the atmosphere for example) and/or to the inlet of the compressor 6 in order to recycle the gas therein. This gas could also be returned to the pressurized gas source 2.

This evacuation of the closed storage volume can for example lower the pressure to a determined value, for example 15 bar.

All or some of the valves can be controlled valves which can be controlled automatically by an electronic controller 17 comprising a data storage and processing device such as a microprocessor or a computer.

This means that the process can be automated. The test (measurement to detect the presence of any oil) can be done at any time before filling or during filling, periodically at each filling, several times per filling or according to any other frequency.

In the event that the sensor 11 detects the presence of oil, the device can be configured to generate a corresponding signal to indicate that the gas leaving the compressor 6 is contaminated. In this case, it may be pointless to repeat the test. The signal generated can interrupt the operation of the compressor and/or warn operators so that they can intervene.

It should be noted that in the case, for example, where all or part of the valves are of the manually actuated type, the optoelectronic level sensor can be replaced or supplemented by piping having a transparent portion. This allows operators to monitor whether or not oil is present (and save the cost of the sensor if applicable).

The downstream end of the bypass pipe 7 can be connected to an oil recovery member 14. Thus, when the pressure in the bypass pipe 7 has been lowered, the third isolation valve 10 can be opened to evacuate the collected oil.

As illustrated, a calibrated orifice 12 can be placed in the bypass pipe 7 downstream of the second isolation valve 9. This allows a progressive increase in pressure downstream to spare the material.

As also illustrated, a pressure sensor 15 can be provided to measure the pressure in the closed storage volume of the bypass pipe 7 (in particular between the second 9 and third 10 isolation valves).

Of course, the invention is not limited to the examples described above. For example, it can be envisaged to remove the second isolation valve 9 from the bypass pipe 7 in certain configurations.

Thus, for example, if the pressure downstream of the compressor is not too high for the oil presence detection sensor 11 (for example less than or equal to 500 bar), the second valve 9 can be omitted. In this case, the first isolation valve 8 is open when the compressor 6 is running. The high-pressure gas is admitted into the bypass pipe 7 through a calibrated orifice and can undergo oil detection in the volume located between the first valve 8 and the end valve 10.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-14. (canceled)

15. A device for filling pressurized hydrogen gas tanks, comprising:
a source of pressurized gas;
a transfer pipe having an upstream end connected to the source and a downstream end intended to be connected to a pressurized hydrogen gas tank that is to be filled, the transfer pipe comprising a compressor and a set of valve(s) for controlling the flow of pressurized hydrogen gas from the source towards the downstream end;
a sensor for detecting a presence of oil in the pressurized hydrogen gas flowing in the transfer pipe downstream of the compressor; and
a bypass pipe connected to the transfer pipe downstream of the compressor that comprises a set of at least two valve(s) in series configured to allow:
i) in a first configuration, the drawing-off, into the bypass pipe, of gas flowing in the transfer pipe, and
ii) in a second configuration, fluidic isolation between the bypass pipe and the transfer pipe in which the set of valve(s) of the transfer pipe defines in the second configuration a closed storage volume for the drawn-off gas trapped in the bypass pipe, the closed storage volume including a pressure reduction system for reducing a pressure of the drawn-off gas that is trapped in the closed storage volume to a value lower than a pressure of the pressurized hydrogen gas flowing in the transfer pipe, wherein the sensor is adapted and configured to detect a presence of oil said closed storage volume.

16. The device of claim 15, wherein the bypass pipe includes an upstream end connected to the transfer pipe downstream of the compressor and a downstream end, the bypass pipe further comprising, and arranged in series between its upstream and downstream ends, first, second, and third isolation valves.

17. The device of claim 16, wherein the sensor detects the presence of oil between the second isolation valve and the third isolation valve.

18. The device of claim 16, wherein the downstream end of the bypass pipe is connected to an oil recovery member.

19. The device of claim 15, wherein the pressure reduction system comprises at least one of: a calibrated orifice and a section of the bypass pipe having an increased cross-section.

20. The device of claim 15, wherein further comprising a pressure sensor measuring a pressure in the closed storage volume.

21. The device of claim 15, further comprising a pipe for evacuating the gas trapped in the closed storage volume, the evacuation pipe comprising an upstream end connected to the bypass pipe in the closed storage volume and a downstream end connected to a discharge volume, the evacuation pipe comprising a set of isolation valve(s).

22. The device of claim 21, wherein the discharge volume is the atmosphere, a zone of the transfer pipe located upstream of the compressor, or the pressurized gas source.

23. The device of claim 15, further comprising an electronic controller comprising a microprocessor or computer, wherein said microprocessor or computer is connected to the sensor for detecting the presence of oil and is configured to generate a signal in the event of oil being detected by said sensor.

24. The device of claim 23, wherein the electronic controller is connected to, and is configured to control, all or some of the valves of the device.

25. The device of claim 15, wherein the sensor for detecting the presence of oil comprises a coalescing filter and a level sensor of the optoelectronic type.

26. A method for filling pressurized hydrogen gas tanks, comprising the steps of:
transferred pressurized hydrogen from a pressurized hydrogen source into a pressurized hydrogen gas tank via a transfer pipe comprising a compressor;
downstream of the compressor, drawing off a volume of the pressurized hydrogen flowing in the transfer pipe towards a bypass pipe;
trapping and expanding said drawn-off volume of pressurized hydrogen in a closed storage volume; and
detecting a presence of oil in the trapped and expanded, drawn-off volume of pressurized hydrogen.

27. The method of claim 26, wherein a pressure of the pressurized hydrogen flowing in the transfer pipe downstream of the compressor is between 500 and 1200 bar and the trapped and expanded, drawn-off volume of pressurized hydrogen is at a pressure of between 500 and 100 bar.

28. The method of claim 26, wherein the drawn-off volume is trapped in a first section of the bypass pipe and said step of expanding the trapped, drawn-off volume is performed in the closed volume, the closed volume having a volume greater than the volume of the first section of the bypass pipe.
